(19) United States
(12) Patent Application Publication
(10) Pub. No.: US 2006/0048804 A1
(43) Pub. Date: Mar. 9, 2006

(54) Transparent combination package for cleaning, spin drying, displaying and storing a paint roller

(76) Inventor: William Robert Walter, Baker City, OR (US)

Correspondence Address: WILLIAM R. WALTER, 2614 FIRST STREET, BAKER CITY, OR, 97814, US

(21) Appl. No.: 10/934,032

(22) Filed: Sep. 3, 2004

(51) Int. Cl. B08B 3/00

(52) U.S. Cl. 134/198

(57) ABSTRACT

This invention has two components, a side delivery spray wand and a transparent plastic package with two compartments. One compartment serves for storage and display of the spray wand, and for guiding and limiting the wand's use in delivering the spray to the paint roller surface. The other compartment serves for storage and display of a paint roller, and is the protective chamber within which a roller is cleaned and spin-dried. The enclosure possesses a small top opening for insertion of the spray wand, and a bottom opening for rapid exhaust of paint-laden solvent. Its two halves are hinged, book-like. When open multiple units nest conveniently. When closed, the compartments are completed, a segment of a paint roller handle is captured, and the seam seals to force all of the paint laden solvent to vent at the exit port.

### RELATED APPLICATIONS

This disclosure covers the design, construction, and use of a clear plastic package, herein termed the “the transparent combination package” which replaces the handled cone element of the PAINT ROLLER AND SPIN DRYER described in U.S. Pat. No. 6,116,255, and incorporates and uses an adaptation of the spray wand element described and protected by that US patent, invented and filed by this same inventor, William R. Walter on May 4, 1998 (application Ser. No. 09/072,072). The “transparent combination package” herein disclosed is a truly novel device, unanticipated in the prior invention, and which possesses features and improvements that enhance its manufacturability, marketability and utility over every patented device reviewed. It was the quest for improving the performance and reducing the production cost of the protective enclosure element of that prior invention, which led to an adaptation of the design to fit a manufacturing process termed “In-line vacuforming”. This adapted design yielded unanticipated, novel and useful features. In addition to the cleaning and spin drying capabilities sought, the resulting package possessed features commending it to serve as a package for the display and storage of paint rollers as well. These features of this design suggested the use of the name “A Transparent Combination Package for cleaning, spin drying, displaying and storing a PAINT ROLLER”, and are deemed to qualify this disclosure as new and novel.

### STATEMENT REGARDING FEDERALLY SPONSERED RESEARCH

N/A

### REFERENCE TO SEQUENCE LISTING, ETC

N/A

### BACKGROUND OF THE INVENTION

1. Field of the Invention

This invention relates to paint roller cleaners, specifically to such cleaners that use water or other solvents and centrifugal action to clean paint rollers.

2. Description of Prior Art

Although four score or more patents of this genre have been issued within the past two decades, paint specialty and general merchandise stores rarely offer any selection. Not one of the 26 patented devices reviewed in depth possesses all of the features herein deemed essential. Such a device must be easy to use, durable, inexpensive and require no maintenance. It must shield the operator and cleaning area from paint and solvent splatter. It must render the roller ready for immediate reuse or storage. It must accommodate the full variety of common paint rollers, and perform its function without having to remove the roller from its handle.

Eight (8) previously patented devices reviewed require removal of the roller cover prior to installation in the device. U.S. Pat. Nos. 4,155,230; 4,237,575, 4,311,158; 4,708,152; 4,733,679; 5,185,938; 5,452,734; 5,487,399.

Seven (7) patents reviewed have been issued for devices which provide no drying action. U.S. Pat. Nos. 4,126,484; 4,155,230; 4,172,373; 4,606,777; 4,765,354; 5,322,081; 5,452,734.

Eight (8) of the reviewed patented devices wash and spin the paint roller through a “plurality of jets”. This attempt to provide “full length cleaning coverage” seriously reduces the penetrating and spinning power available in normal domestic water systems. Likewise, unless the jets are closely spaced, these devices leave poorly cleaned bands on the paint roller. U.S. Pat. Nos. 4,130,124; 4,446,590; 4,708,152; 5,050,626; 5,402,808; 5,505,220; 5,614,021; 5,626,158.

One (1) U.S. Pat. No. 4,108,189 provides a “fan-shaped” discharge of water “contacting the roller throughout its entire length”. Being continuous, such a spray action would eliminate the “banded cleaning effect” of the previous eight devices, but it shares the main problem, a serious reduction in penetrating and spinning power by spreading that force over the entire length of the roller.

One (1) U.S. Pat. No. 3,075,534 issued to A. Harbostad in 1963 has some of the above listed essential features. The principal defect of this device is its limited usability. The only paint rollers which will fit the device are those with 90 degree bends in the handle. Most of the paint roller handles on the market would not fit this device, even if it were available. Other defects include enclosed bottom, seriously occluded exhaust which allows accumulation of swirling liquid during spin drying as well as design features adversely effecting manufacturability and cost.

One (1) U.S. Pat. No. 6,116,255 issued to this applicant, William R. Walter in 2000, was earlier deemed to answer all of the deficiencies and drawbacks of previous devices. However, manufacturing and marketing the device yielded evidence of the need for at least three improvements: (1) elimination of even an occasional splatter out of the open top, (2) a design more amenable to mass production and (3) production and distribution cost reductions.

3. Summary of Defects and Disadvantages of Prior Patented Paint Roller Cleaners:
a) Cleaners that feature removal of the roller from the handle prior to cleaning require the operator to handle the paint covered roller. This is time consuming and messy.
b) Devices which leave the finished roller too wet for immediate reuse or for storage.
c) Devices which cannot provide deep cleaning and high speed spin action because the available force of the spray is spread throughout the full length of the roller.
d) Devices that are unable to accommodate the variety of common roller designs.
e) Devices such as my own invention, cited earlier, where the process is not always fully and dependably contained, where further cost reductions can be achieved by design modifications, or where previously unanticipated features can add to its usefulness.

4. Conclusion Drawn from Analysis of Prior Art

A need yet remains for a device which possesses all of the characteristics essential to answer the deficiencies described above.

### SUMMARY OF THE INVENTION

Disclosed herein is an apparatus whereby a paint roller can quickly be cleaned, fluffed, and rendered damp-dry, with the operator and cleaning area completely shielded from the splatter of solvent and paint. The washing and spin-drying actions are produced by a high velocity single jet of water, or other solvent, delivered through a hand-held spray wand within the confines of a clear plastic enclosure. This enclosure envelops the roller whether for display, cleaning, spin-drying, or storage. The enclosure possesses a small top-opening for insertion of the side delivery spray wand, and a bottom-opening for rapid exhaust of paint-laden solvent, and is sealed along the seams where the two halves of the closed package join to force all of the paint laden solvent to vent at the designed exit port. The enclosure mates with a segment of a paint roller frame in such a way that the roller handle protrudes, permitting the operator to hold the roller, with the transparent combination package firmly attached, in the hand of choice, and to manipulate the spray wand with the other hand.

### DETAILED DESCRIPTION OF THE INVENTION

### A Transparent Combination Package for Cleaning, Spin Drying, Displaying, and Storing a PAINT ROLLER

Disclosed herein is a device with four discrete functions relating to paint applicator tools known as paint rollers: first, it serves as a display package for a fully assembled paint roller; second, it functions as a cleaning or washing device for a paint roller; third, it functions as a spin-drying device for a paint roller; and finally, it serves as a storage package both for the device and for a paint roller.

This device has two components, a spray wand and a package or compartmented enclosure. One compartment of the package is designed to accommodate the spray wand for use, display and storage. A second compartment of the package is designed for containment of the processes of cleaning and spin drying, as well as for the display and storage of the paint roller.

The spray wand is a tubular device possessing a connection end and a spray delivery end. For use, the wand is removed from its compartment, connected to a high pressure cleaning fluid source, typically cold water, and re-inserted into the same compartment to deliver a high velocity jet of fluid perpendicular to the wand axis in order to serve both the cleaning and spin drying functions.

The package possesses four major features: transparency, handle indexing channels, a roller chamber, and a spray wand channel. Minor features of the package include a keyed wand insertion opening, roller handle exit ports, a fluid exhaust port, hinge, fasteners, fluid seals, opening tabs, holes for hanging, and spaces for information such as advertising and instructions. All of the features of the package are provided for by the material selected for its construction and by the formation of those materials.

Transparency is an essential feature for the device to function as a display package and useful in its other functions. The handle indexing channels serve to hold a paint roller handle firmly in such a fashion that an attached roller is free to rotate within the roller chamber. The spray wand channel is aligned alongside the roller chamber with open communication along the full length of both, providing a spray pathway from the wand channel into the roller chamber, and designed so as to limit the spray wand's range of rotation and prevent its inadvertent withdrawal. The roller chamber when closed is cylindrical in shape, with space at both ends and within its circumference to allow an enclosed roller to spin freely. The chamber is sealed to contain the cleaning process, to collect all the paint-laden solvents and to deliver them through the exhaust port into an appropriate receptacle.

When the device is used as a display package the side-delivery spray wand appears in the spray wand channel side by side with a paint roller installed in the roller chamber. When used as a cleaning device and as a spin/drying device the spray wand is removed from its channel, its connection end is attached to a hand control valve supplied with a source of solvent under pressure, and its spray delivery end is inserted through the keyed insertion opening into the spray wand channel for the delivery of a high velocity jet of solvent to serve the cleaning and spin drying processes. The package has continued usefulness as a permanent storage receptacle for the spray wand and for the paint roller with its installed cover, available for reuse again and again.

This combination package can be thought of as a simple enclosure formed from a single sheet of clear plastic, having front and back halves, which are hinged, book like, to form the complete unit. When open flat, numerous enclosure units may be stacked for efficient quantity packaging. Its simplicity and low unit cost commend it for adaptation to fit nearly any conceivable style or size of paint roller.

The package is very light and is firmly supported by the paint roller handle frame to which it is affixed by the indexing channels. Thus installed the handle of the paint roller protrudes from the package permitting the operator to grasp it with the hand of choice as when applying paint, leaving the other hand free to manipulate the side delivery spray wand as needed to deliver a jet of solvent to the paint laden roller fibers in the cleaning and spin drying process.

### BRIEF DESCRIPTION OF THE DRAWINGS

### A Transparent Combination Package for Cleaning, Spin Drying, Displaying, and Storing a PAINT ROLLER

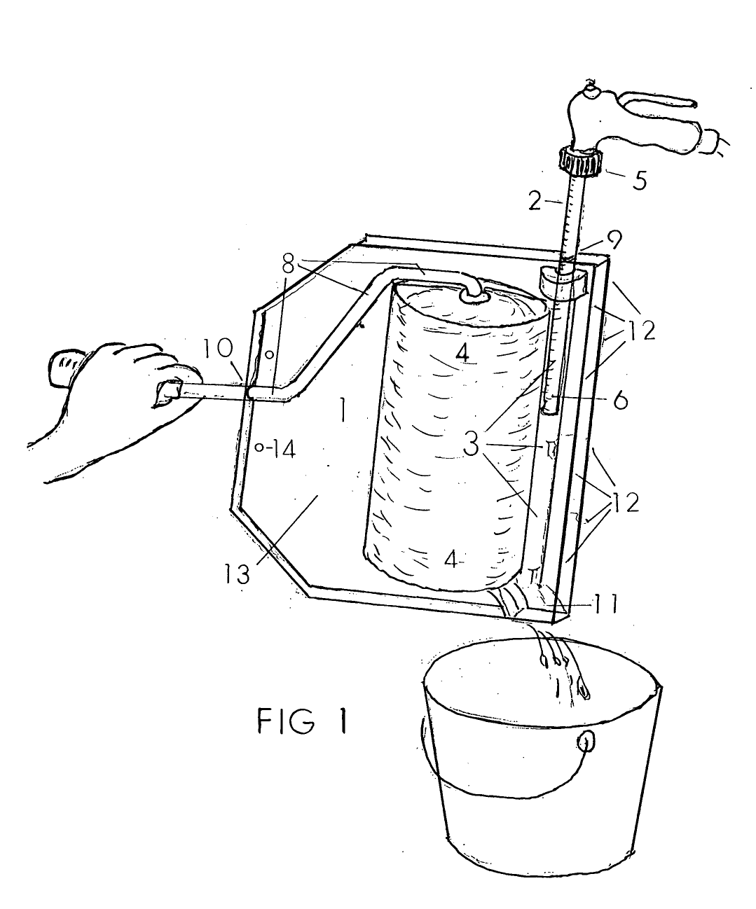

FIG. 1 is a perspective view of the transparent Combination Package with installed paint roller undergoing the cleaning/spin-drying process. (Suggested for cover)

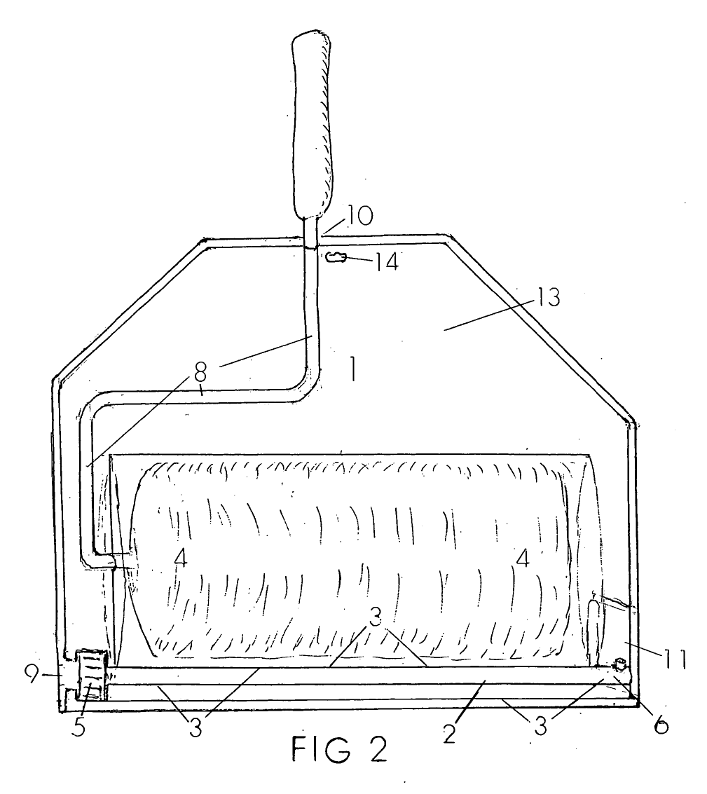

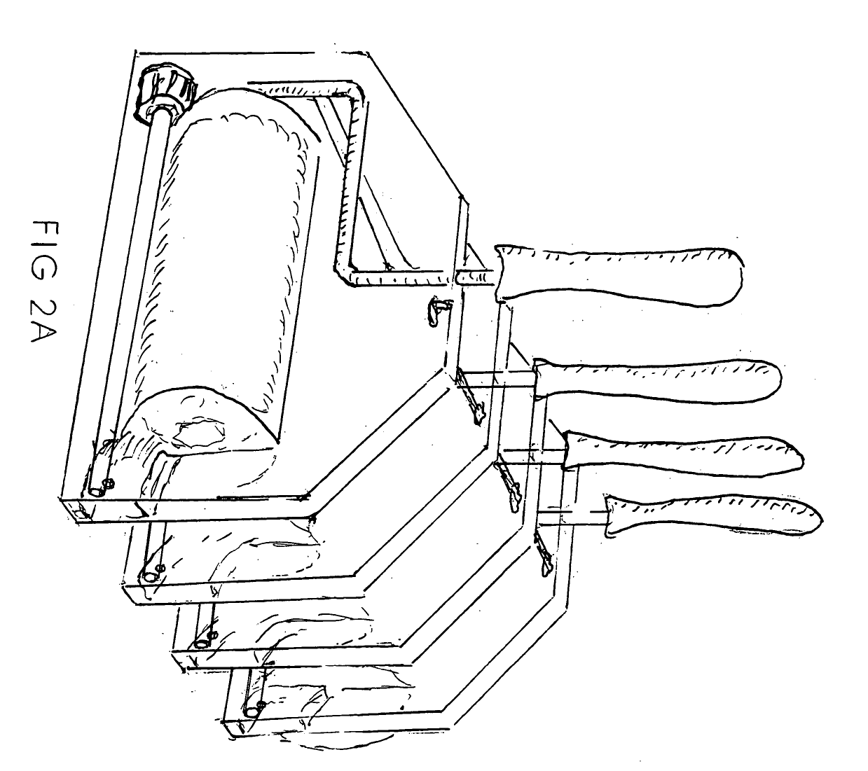

FIG. 2 is a front view of the transparent Combination Package with paint roller and spray wand installed, illustrating a typical display.

FIG. 2A is a perspective view to illustrate a typical display of several Transparent Combination Package units, each with an enclosed paint roller and spray wand.

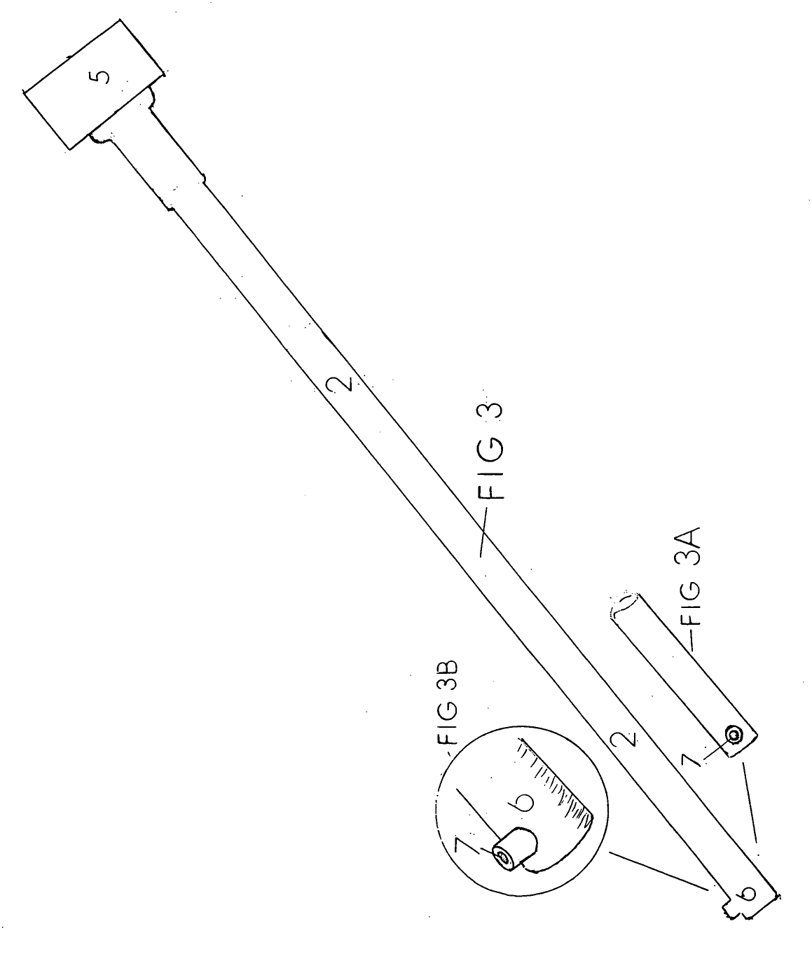

FIG. 3 is a side view of a typical spray wand.

FIG. 3A is a spray wand delivery end rotated 90 degrees.

FIG. 3B is a spray wand delivery end enlarged and rotated 45 degrees

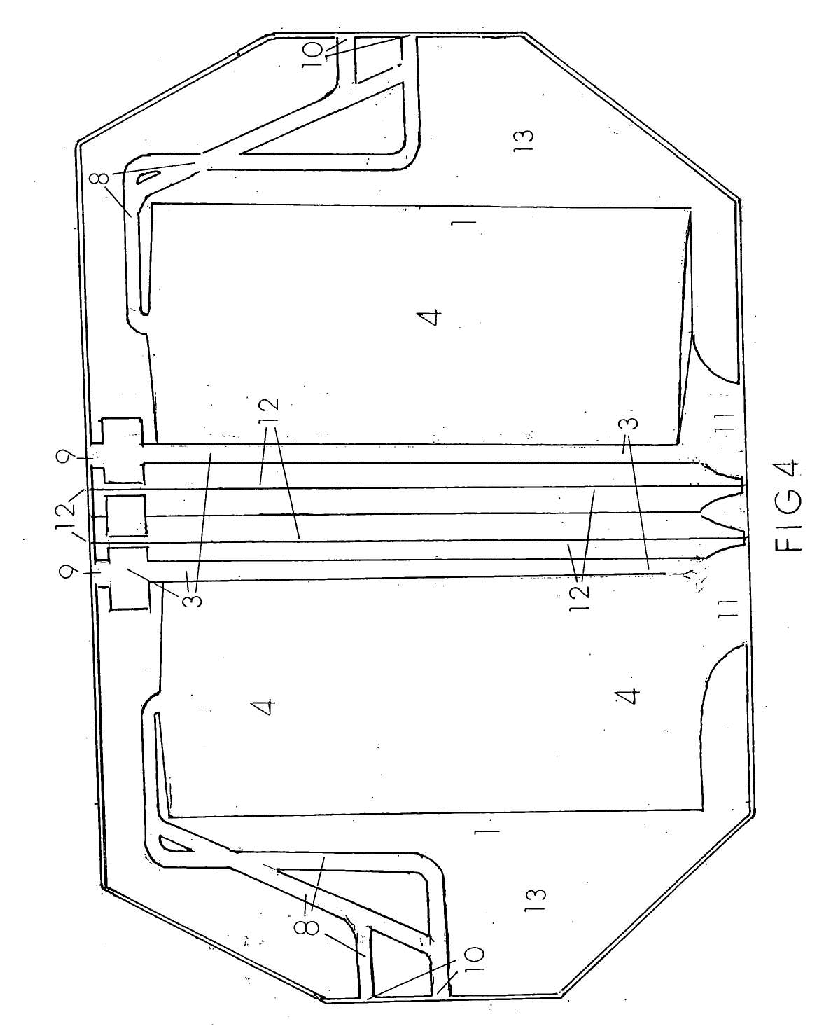

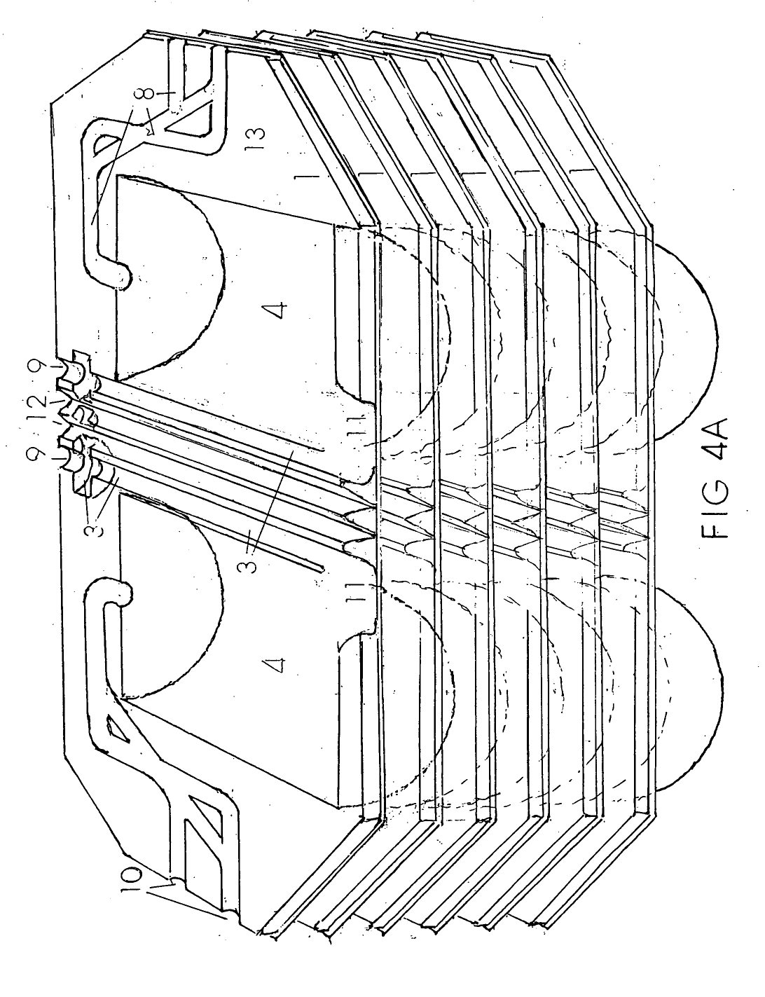

FIG. 4 is a top plan view of a Transparent Combination Package shown flat (open).

FIG. 4A is a perspective view of a stack of transparent combination Packages illustrating nesting.

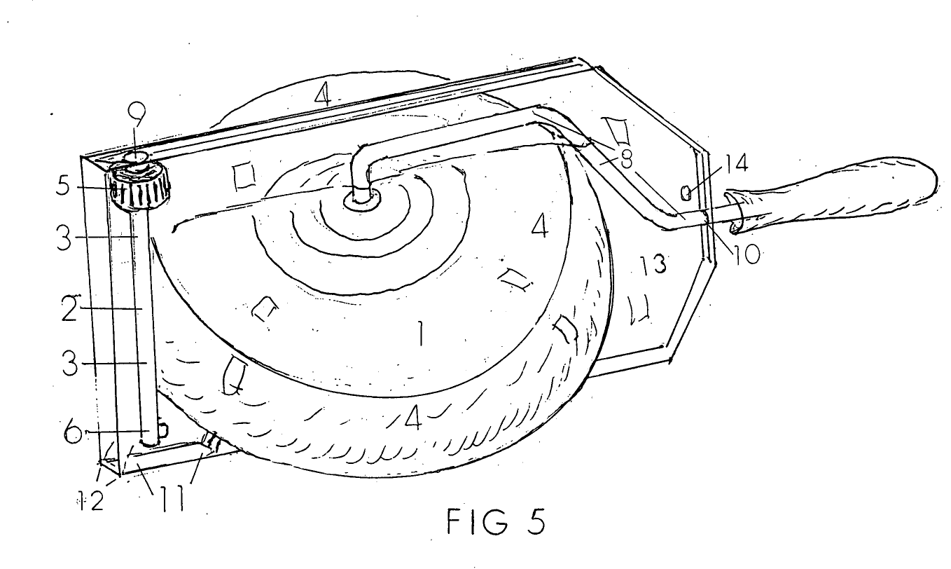

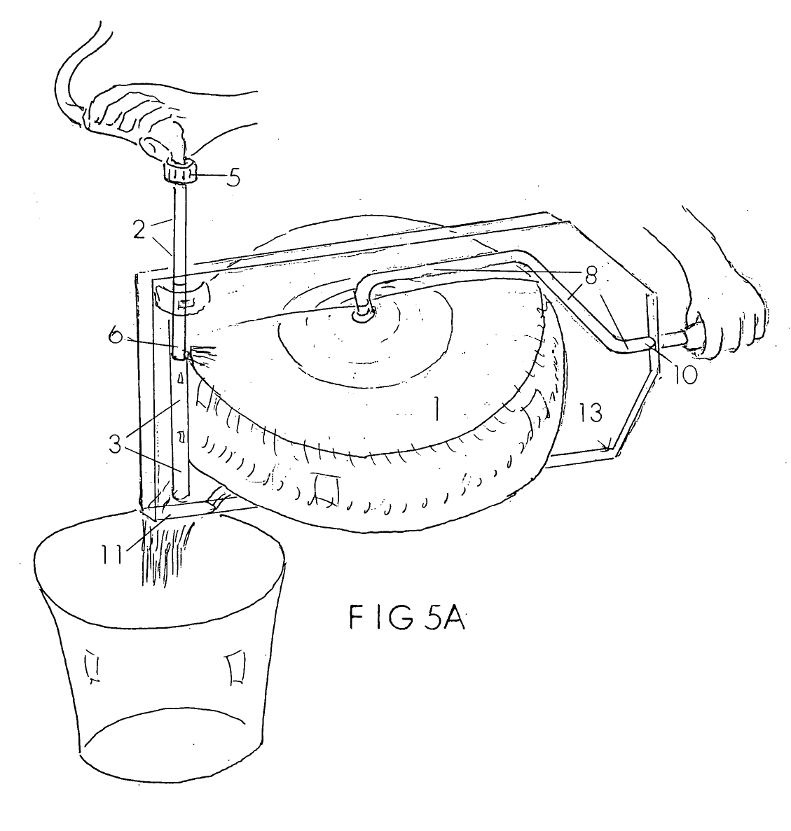

FIG. 5 is a perspective view of a Transparent Combination Package designed for a specialty paint roller which is displayed therein along with spray wand for sale or storage

FIG. 5A is a perspective view of a transparent Combination Package designed for a specialty roller illustrating the cleaning/spin-drying process.

### REFERENCES TO SPECIAL FEATURES OF DRAWINGS

### A Transparent Combination Package for Cleaning, Spin Drying, Displaying, and Storing a PAINT ROLLER

1—transparent combination package
2—spray wand
3—spray wand channel
4—roller chamber (cleaning chamber)
5—connection end of spray wand
6—spray delivery end of spray wand
7—spray orifice
8—handle indexing channels
9—wand insertion opening
10—roller handle exit port(s)
11—fluid exhaust port
12—hinge
13—space for inserting informative art
14—holes for hanging
   Use of the Device with References to the Drawings
   1. Used as a Display Package

Hanging holes 14 are provided permitting efficient arrangement of a number of units offered for sale. A painter might be attracted to a display such as is represented in FIGS. 2 and 2A and FIG. 5, and by graphics installed in the space provided 13.

2. Used for Cleaning a Paint Roller

a. Set Up

After completing the painting, the painter returns the paint-laden roller 4 to its place in the package 10, removes the spray wand 2, closes the package 1, and secures the holding devices (not represented). The connection end 5 of the spray wand 2 is attached to any standard male hose connector supplied with solvent, preferably cold water, the supply being under operator control as with the commonly used pistol grip hand control valve. The operator inserts the delivery end 6 of the spray wand 2 into the spray wand channel 3 where a strong jet of solvent is released and directed toward the paint laden roller fibers. The spray is completely contained within the transparent combination package thus protecting the operator and the cleaning area from paint and solvent splatters.

b. Soak Mode

Typically the process begins with the jet of solvent being directed perpendicularly toward the center axis of the paint roller where the jet's power penetrates the fibers most effectively without inducing roller rotation. The spray wand is gradually inserted fully into the channel to soak the roller from end to end; and then, by directing the jet slightly to one side of roller center rotation will begin to occur. With a slow rate of roller rotation established, repeated movement of the spray wand out and in permits the complete surface of the roller to become saturated with solvent.

c. Spin Mode

A rapid spinning of the paint roller is induced by simply directing the full power of the jet of solvent toward the outer perimeter of the roller. If the spin mode is entered with the roller surface incompletely saturated with solvent the unbalanced condition of the roller will result in momentary wobbling until balance is achieved through the off-throwing of paint laden solvent and near dryness occurs. Spin mode can be entered gradually or abruptly as the operator chooses and is determined by the angle at which the jet of spray is caused to impinge upon the roller surface.

d. Thorough Cleaning

Repeating the soak cycle and the spin cycle a few times may be necessary to assure that all of the paint residue has been removed from the roller pile. Most paint rollers can be rendered damp dry and ready for immediate reuse by continuing the spin cycle until maximum rotational velocity occurs, and then by ending the process by abruptly shutting off the water supply to the spray wand during that moment of maximum rotational velocity. The more rapid the rotation, the more effective the drying action will be, and the longer the duration of high velocity spin after the spray is terminated the more effective the drying action will be.

e. Residue Removal

During the spin process the off-thrown solvent collects on the inner surface of the roller chamber and flows downward in a swirling motion toward the fluid exit port 11. The bottom surface of the roller chamber 4 is designed to deliver the fluid through the exit port 11 for rapid and complete removal of all solvent and paint residue. The exit port 11 is designed to concentrate the waste liquids for delivery as a single stream into any appropriate collection device.

3. Used for Storage

Preparation for long term storage should include opening the package to place the spray wand in its channel and to allow the damp roller fibers to dry thoroughly. The package is then closed, fastened, and placed where heavy objects are unlikely to crush it. Hanging holes 14 are provided to permit the device to be hung on a convenient nail or hook.

I claim:

1. A device which serves as an apparatus for cleaning and spin drying various types of paint rollers in common use without removing a paint roller from a handle, and which also serves as a container for displaying and storing said device with a paint roller and handle comprising:
a wand means for delivering a jet of solvent at 90 degrees to said wand axis for deep cleaning and for inducing roller spin, wherein said wand consists of an elongated tubular element with connecting means to a standard hand control valve for an operator to hold, control, and deliver solvent under pressure into said elongated tubular element, wherein a terminal end of said tubular element is sealed off and perforated a short distance from said terminal end with a spray orifice penetrating perpendicularly to form a fluid communication between a hollow center of said tubular element and an outer surface;
a container means for displaying and storing both said spray wand and a paint roller, and for containing a cleaning and spin drying process to protect an operator and a cleaning area from solvent and paint residue splatters, wherein said container means is formed as a single unit from clear plastic material, with front and back sides which are hinged, book like, in such a fashion as to constitute said container when closed, said container possessing four major features: transparency, handle indexing channels, a roller chamber, and a spray wand channel; said container being constructed of sturdy, light, transparent plastic, permitting its contents to be fully visible whether being displayed for sale or being subject to a cleaning/drying process; said handle indexing channels serving to affix a paint roller handle firmly so that its attached roller is held inside said roller chamber in such a fashion that a roller is free to spin without its fibers touching an inside surface of said roller chamber; said spray wand channel being aligned alongside said roller chamber with a range of open radial communication along the full length of said roller chamber sufficient to allow the direction of a high velocity jet of solvent by means of said spray wand into said roller chamber along the full length of the roller chamber and at angles ranging from directly into the roller pile for deep penetration and minimum rotation of the roller to angles incident to the roller surface such as to achieve the high spin velocity required for the spin drying process.

2. A package designed to contain wholly or in part a paint roller handle with a paint applicator sleeve installed, said package being formed of clear plastic, shaped and molded to possess features and compartments appropriate for any or all of the particular functions providers and users of said package might deem useful; such as: advertisements, promotional devices or materials, instructions, attachments, tools or any other equipment or materials that serve the painting and clean-up process.

3. The apparatus of claim 1 wherein a permutation of said spray wand features a protruding spray orifice attached to said tubular element and extending outward perpendicularly from said wand axis to form a fluid communication between a hollow center of said tubular element to a point of delivery somewhat beyond an outer surface, said extended spray orifice serving as a physical stop means to limit rotational movement of said spray wand within said spray wand channel and to prevent inadvertent withdrawal of said spray wand from spray wand entry opening.

4. The apparatus of claim 1 wherein a permutation of said container means features a specially designed spray wand channel which is designed to limit rotation of said spray wand as described in claim 3 to that range of rotation as is best suited to serve the cleaning and spin drying processes.

5. The apparatus of claim 1 wherein a permutation of said container means features a keyed spray wand entry opening which is designed to require the operator to rotate said spray wand as described in claim 3 to a precise position for either insertion or withdrawal.
